(19) United States
(12) Patent Application Publication
(10) Pub. No.: US 2012/0270335 A1
(43) Pub. Date: Oct. 25, 2012

(54) REACTIVE POLYMERS FOR SOLID-PHASE EXTRACTION

(75) Inventors: Sergey Piletsky, Bedfordshire (GB); Olena Piletska, Bedfordshire (GB); Raymond Douglas Coker, Bromley (GB)

(73) Assignee: Toximet Limited, Sittingbourne (GB)

(21) Appl. No.: 13/391,706

(22) PCT Filed: Aug. 26, 2010
(86) PCT No.: PCT/GB2010/051419

§ 371 Date: Jun. 27, 2012

(30) Foreign Application Priority Data
Sep. 3, 2009 (GB) 0915329.7

(51) Int. Cl. G01N 21/64

(52) U.S. Cl. 436/501; 422/69

(57) ABSTRACT

Apparatus, methods and polymers for solid phase extraction by binding an analyte containing a primary amino group. The polymer is a reactive polymer, wherein binding of the analyte to the polymer causes fluorescent isoindole complex formation. A method of binding comprises use of an SPE carrier, such as an SPE cartridge, loaded with a reactive polymer. Binding of an analyte is detected by observing changes in fluorescence after applying the analyte to the polymer. Fluorescence can be detected using a fluorometer or transilluminator, for example. In a preferred embodiment, the reactive polymer is prepared from a monomer mixture comprising acetonitrile and triethylamine.

### FIELD OF THE INVENTION

The present invention relates to reactive polymers for solid-phase extraction (SPE) and to the detection of analytes using fluorescent isoindole complex formation.

### BACKGROUND OF THE INVENTION

A wide variety of human foods and animal feeds, including edible nuts, oilseeds, cereal grains, forages and products derived from them are susceptible to contamination by mycotoxins, which are toxic metabolic by-products of fungi. Contamination can occur on food and feed crops before and/or after harvest. Among the most significant mycotoxin contaminants are the aflatoxins and ochratoxins. Direct determination of mycotoxin level is an important aspect of quality control in foods and feeds.

Such measurements have conventionally been carried out using high performance liquid chromatography (HPLC). However in cases where HPLC equipment is not available or appropriate, determination by thin layer chromatography (TLC) is also possible. Commercial scanners are available for mycotoxin determination of samples that have been subject to TLC separation. The scanners use mercury lamps with an emission wavelength of 366 nm as a light source to stimulate fluorescence. Fluorescence is then detected and quantified by photo-multipliers.

In some thin layer chromatography matrices the adsorbent layer contains an inorganic phosphorescent or organic fluorescent indicator. In these systems, detection of analytes relies on the quenching of phosphorescence or fluorescence by the sample components. Analytes capable of quenching background fluorescence include chemicals containing aromatic moieties—for example large macrolides, such as antibiotics and other natural products.

Before a solution obtained by extraction from a foodstuff sample is subjected to quantitative measurement, the solution may be subjected to a ‘clean-up’ procedure. Clean-up generally involves using solid-phase extraction to remove compounds that may interfere with the mycotoxin evaluation.

Qualitative detection of mycotoxins can be carried out using small chromatographic columns (so-called ‘minicolumns’) in which the mycotoxins are immobilised as a layer within a mineral adsorbent in the minicolumns. The minicolumns are viewed under ultraviolet light to cause the immobilised mycotoxin to fluoresce. Various minicolumn methods have been adopted as official tests of the AOAC (Association of Official Analytical Communities) International to check for the presence of mycotoxins.

For the quantitative assay of mycotoxins, WO 2006/123189 describes fluorometric apparatus for assessing mycotoxin samples immobilised in layers in minicolumns. The apparatus can also be used to assess mycotoxins immobilised in molecularly imprinted polymers and non-molecularly imprinted (blank) polymers provided as adsorbents in solid phase extraction (SPE) cartridges.

Such a system comprising an SPE cartridge and fluorometric apparatus can be used to detect analytes other than mycotoxins. Alternative applications within the food sector include the measurement of pesticide and veterinary residues, algal toxins, illicit dyes (e.g. Sudan I), and indicators of food quality. Outside the food sector, areas where the cartridges and apparatus can potentially be used include the control of environmental pollutants, drug abuse and counterfeit drugs. Applications could also be found in the forensic and healthcare sectors.

In a conventional SPE cartridge, a molecularly imprinted or blank polymer adsorbent is used to selectively adsorb an analyte. Binding is detected by observing the fluorescence of any bound compounds. The present invention is based on use of a reactive polymer to detect binding by means of fluorescent isoindole complex formation.

### SUMMARY OF THE INVENTION

In one aspect, the present invention provides a reactive polymer for use as an SPE adsorbent. Apparatus comprising an SPE carrier loaded with a reactive polymer forms another aspect of this invention. In use, adsorption of an analyte having a primary amino group onto the reactive polymer causes fluorescent isoindole complex formation.

In the preferred embodiment, the reactive polymer comprises o-phthaldialdehyde and allyl thiol.

Preferably, the polymer further comprises ethyleneglycol dimethacrylate (EGDMA) as cross-linker and 1,1′-azobis(cyclohexanecarbonitrile) as initiator. More preferably, the monomer mixture used in polymer fabrication comprises one or more organic solvent, such as acetonitrile, methanol or triethylamine.

The SPE carrier is typically a cartridge, tube, cuvette, rod or flat surface.

Optionally, the SPE carrier further comprises a non-reactive polymer capable of selectively binding an analyte.

The present invention is particularly suitable for adsorbing DNA, fumonisin B1, Atenolol, Abacavir glutarate, Vitamin B1 and bovine serum albumin (BSA).

To detect fluorescent isoindole complex formation, it is preferable to use a Toximet-T instrument and/or a transilluminator.

In another aspect of the present invention there is provided a method of analysing a sample comprising the steps of: providing an SPE carrier loaded with a reactive polymer, the reactive polymer being suitable for binding an analyte having a primary amino group, such that binding results in fluorescent isoindole complex formation; applying the sample to the reactive polymer; and detecting any change in fluorescence emission.

The method is particularly suitable for analysing compounds such as DNA, fumonisin B1, Atenolol, Abacavir glutarate, Vitamin B1 or bovine serum albumin (BSA).

Fluorescence of the fluorescent isoindole complex is ideally detected using a Toximet-T instrument and/or a transilluminator.

Preferably the polymer comprises o-phthaldialdehyde and allyl thiol. More preferably, the polymer further comprises EGDMA as cross-linker and 1,1′-azobis(cyclohexanecarbonitrile) as initiator. Suitably, the polymer is fabricated using a monomer mixture comprising acetonitrile and triethylamine.

The SPE carrier ideally further comprises a non-reactive polymer capable of selectively binding an analyte.

Another aspect of the present invention encompasses the use of a reactive polymer as an SPE adsorbent for quantifying analyte adsorption.

In the preferred embodiment, the reactive polymer is made using a monomer mixture comprising o-phtaldialdehyde, allyl thiol, EGDMA as cross-linker, 1,1′-azobis(cyclohexanecarbonitrile) as initiator, acetonitrile and triethylamine.

### BRIEF DESCRIPTION OF THE DRAWINGS

FIG. 1 illustrates the change in emission spectra of a reactive polymer suspension in response to the addition of NH₄OH;

FIG. 2 illustrates fluorescence emission after adsorption of DNA onto a reactive polymer measured using a Toximet-T instrument;

FIG. 3 illustrates DNA adsorption onto a reactive polymer monitored using a transilluminator;

FIG. 4 illustrates fluorescence emission after adsorption of different amounts of DNA onto a reactive polymer measured using a Toximet-T instrument;

FIG. 5 illustrates fluorescence emission after adsorption of fumonisin onto a reactive polymer measured using a Toximet-T instrument;

FIG. 6 illustrates fumonisin B1 adsorption onto a reactive polymer monitored using a transilluminator;

FIG. 7 illustrates fluorescence emission after adsorption of Atenolol onto a reactive polymer measured using a Toximet-T instrument;

FIG. 8 illustrates fluorescence emission after adsorption of Abacavir glutarate onto a reactive polymer measured using a Toximet-T instrument;

FIG. 9 illustrates Abacavir glutarate adsorption onto a reactive polymer monitored using a transilluminator;

FIG. 10 illustrates fluorescence emission after adsorption of Vitamin B1 onto a reactive polymer measured using a Toximet-T instrument;

FIG. 11 illustrates Vitamin B1 adsorption onto a reactive polymer monitored using a transilluminator;

FIG. 12 illustrates fluorescence emission after adsorption of BSA onto a reactive polymer measured using a Toximet-T instrument; and

FIG. 13 illustrates BSA adsorption onto a reactive polymer monitored using a transilluminator.

### DETAILED DESCRIPTION OF THE INVENTION

In the preferred embodiment, a reactive polymer comprising o-phthaldialdehyde, allyl thiol, EGDMA as cross-linker, 1,1′-azobis(cyclohexanecarbonitrile) as initiator, acetonitrile and triethylamine is prepared.

To increase the surface area of the reactive polymer available for binding the analyte, the polymer can be made porous. A porous polymer is prepared by polymerising a functional monomer and a cross-linker in the presence of a porogen. A porogen is a material that is dispersible in the monomers (and remains dispersed in the polymers after reaction of the monomers) and that can be removed after the polymer is formed to generate pores within the polymer.

A suitable porogen is inert in the polymerisation reaction. Porogens may be solids, liquids or gases. Solids or liquids can be removed by decomposition or by ‘dissolving-out’ with a suitable solvent. In the preferred embodiment of the present invention, a liquid porogen is used that can be finely dispersed in the polymerisation mixture by stirring, and can be removed by washing the polymer with a suitable solvent.

When the functional monomers are cross-linked with EGDMA, then a particularly suitable porogen is N,N-dimethylformamide (DMF). Acetonitrile, methanol, toluene, ethanol, glycerol, water or other solvents or mixtures thereof used for radical polymerisation may also be used.

The prepared reactive polymer is loaded into an SPE cartridge to generate apparatus in accordance with the present invention.

Prior to use in any analyses, the SPE cartridge packed with reactive polymer is conditioned with a buffer.

Suitable analytes for use with the preferred embodiment of an SPE carrier loaded with a reactive polymer include: DNA, fumonisin B1, Atenolol, Abacavir glutarate, Vitamin B1 and bovine serum albumin (BSA).

In use of the apparatus, once an analyte comprising primary amino groups is loaded onto the reactive polymer, binding of the primary amino groups of the analyte to the reactive polymer occurs according to the following reaction scheme:

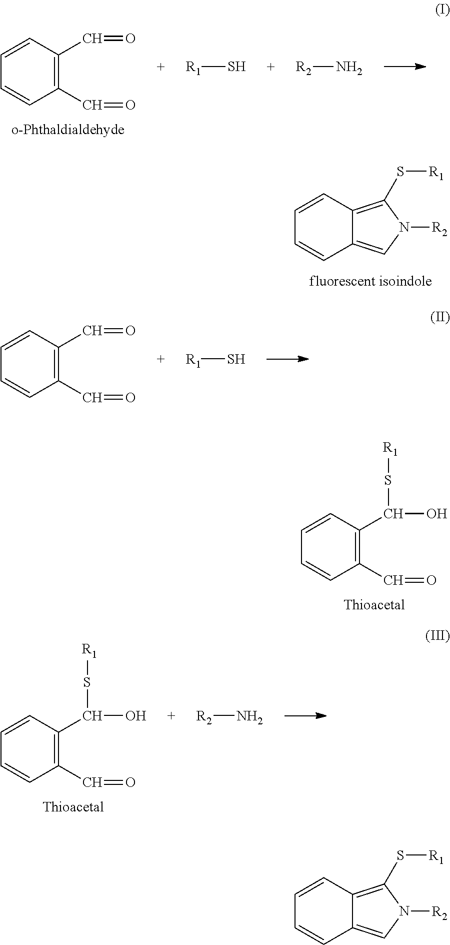

Where R₁—SH=allyl thiol and R₂—NH₂=analyte comprising primary amino groups

Formation of fluorescent isoindole complexes generates fluorescent emission. This fluorescent emission is measured using a Toximet-T machine and/or transilluminator.

In order to generate a sharp band of the target analyte towards the top of the SPE cartridge, a polymer selective for the target analyte can be added to the reactive polymer within the cartridge.

### EXAMPLE 1

### Polymer Preparation

Polymers were prepared as described in the publication “A new reactive polymer suitable for covalent immobilisation and monitoring of the primary amines (2001), Piletska E. V., Piletsky S. A., Subrahmanyam S., Turner A. P. F., Polymer, 42, 3603-3608”.

A polymer mixture comprising 2 ml of cross-linker EGDMA, 134 mg of ortho-phthaldialdehyde (OPA), 148 mg of allyl thiol (AT), 2 ml of acetonitrile, 6 mg of triethylamine and 100 mg of initiator 1,1′-azobis(cyclohexanecarbonitrile) was prepared.

The mixture was degassed with nitrogen and polymerised for 12 h at 80° C. The resulting polymer was ground and sieved in methanol to obtain fraction with size 45-125 μm. The polymer fraction was thoroughly washed with methanol, dried and packed in empty 1 ml SPE cartridges (Phenomenex, UK).

Prior to use, the packed SPE cartridges were conditioned with 100 mM sodium borate buffer (BB), pH 9.5. In all analyses, target analyte compounds were also diluted in BB prior to loading onto the packed cartridges.

The prepared polymer had no significant fluorescent properties. Background light-scattering in the polymer after conditioning with borate buffer was acceptable. Therefore, the polymer was suitable for use in detecting analyte binding by means of fluorescent isoindole complex formation.

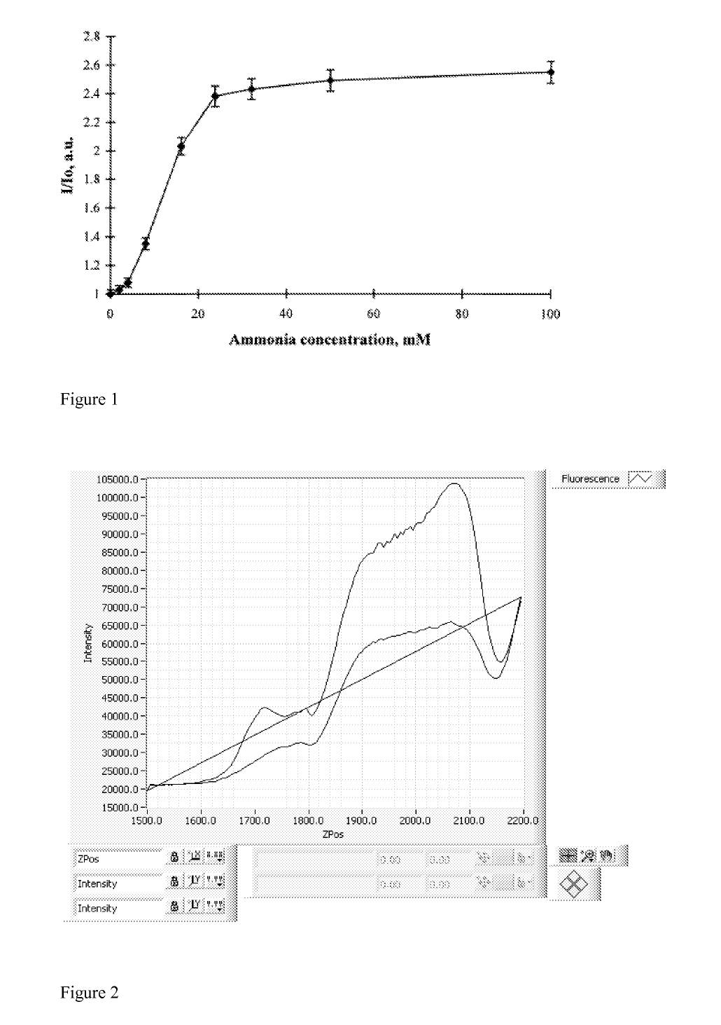

After addition of compounds comprising primary amino groups to a packed SPE cartridge, fluorescence developed (FIG. 1). The excitation and emission maximum were 360 nm and 434 nm respectively.

### EXAMPLE 2

### DNA

DNA from Promega (100 by DNA ladder, catalogue number—G2101, Promega) was used. 1 μl of DNA (40 ng) was dissolved in 1 ml of BB, pH 9.5, and loaded onto an SPE cartridge packed with the reactive polymer of Example 1 (75 mg per cartridge). Cartridges were pre-conditioned with 1 ml of 100 mM BB, pH 9.5.

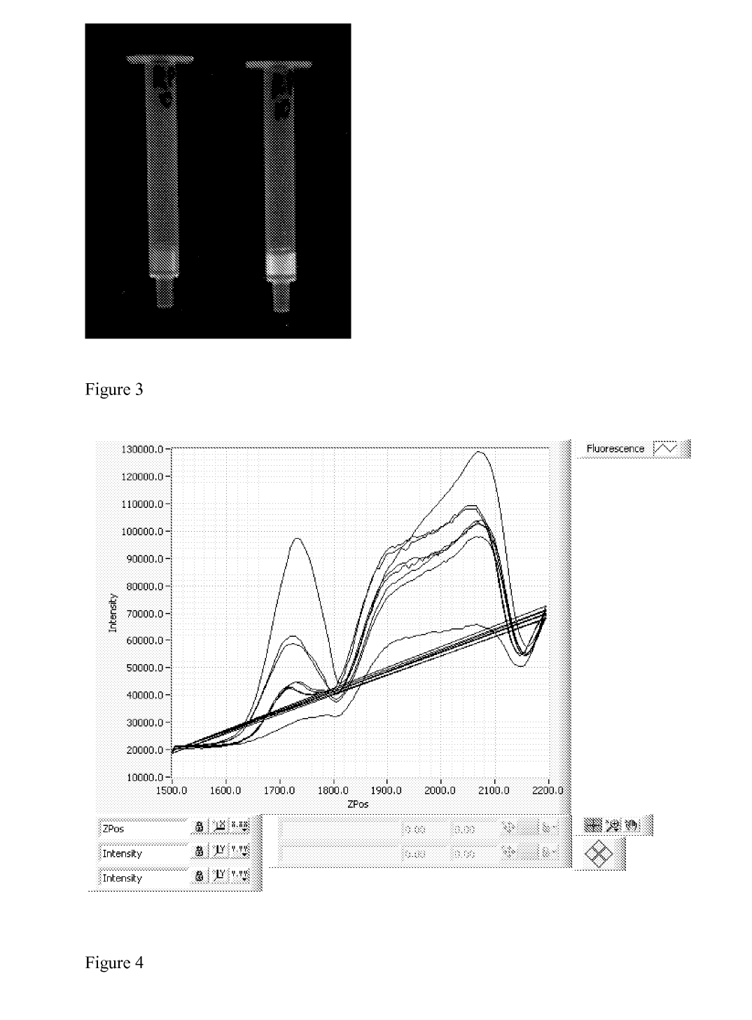

An increase in fluorescence was observed after application of DNA to the packed SPE cartridge (FIGS. 2 and 3).

Several different amounts of DNA were loaded onto the packed SPE cartridge and a cumulative effect was observed (FIG. 4)

### EXAMPLE 3

### Fumonisin B1

1 μg of fumonisin B1 was diluted in 1 ml of BB, pH 7.5, and loaded onto an SPE cartridge packed with the reactive polymer of Example 1 (previously conditioned with 100 mM BB, pH 9.5).

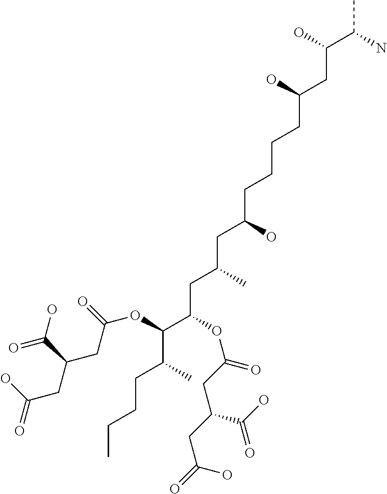

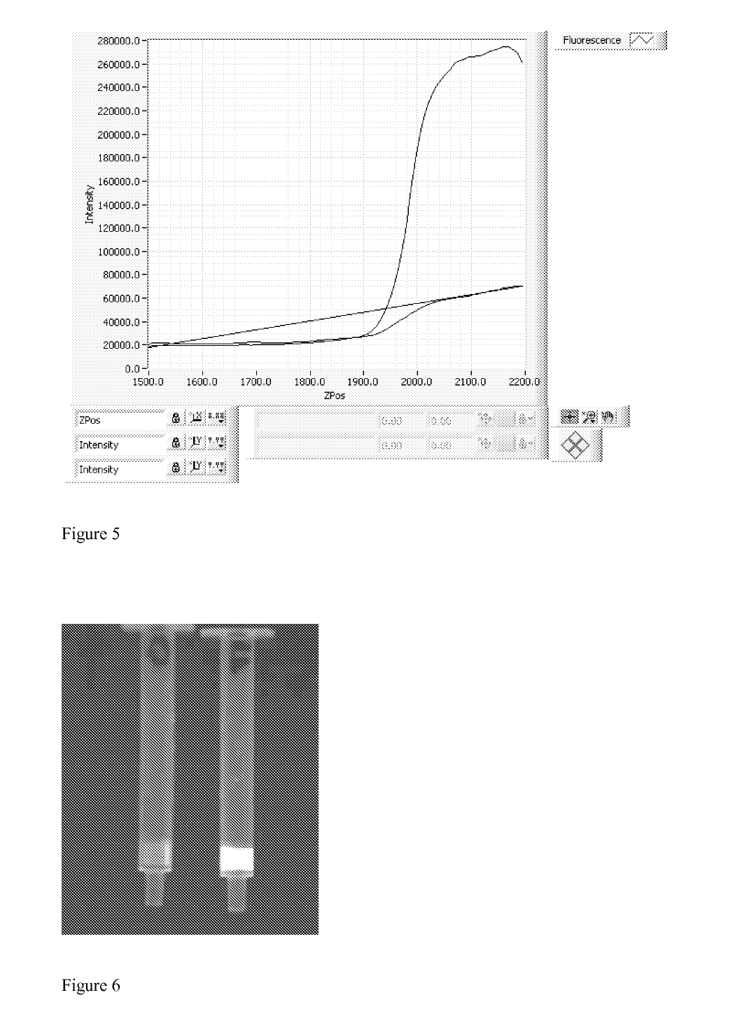

Fumonisin B1 bound to the polymer and generated a significant increase in fluorescence (FIG. 5) which was detected using a Toximet-T instrument and transilluminator (FIGS. 5 and 6).

### EXAMPLE 4

### Atenolol

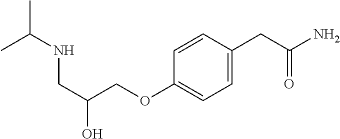

1 mg of Atenolol was dissolved in 1 ml of BB, pH 7.5, and loaded onto an SPE cartridge packed with the reactive polymer of Example 1 (previously conditioned with 100 mM BB, pH 9.5).

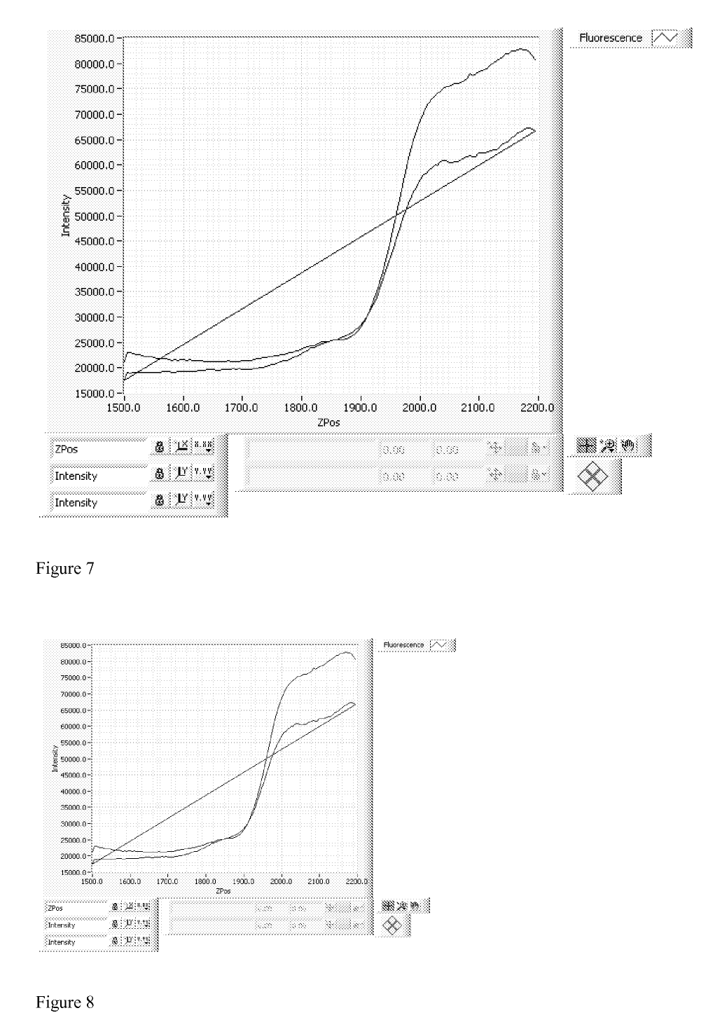

Atenolol bound to the polymer and generated an increase in fluorescence (FIG. 7) which was detected using a Toximet-T instrument.

### EXAMPLE 5

### Abacavir Glutarate

1 mg of Abacavir was dissolved in 1 ml of BB, pH 7.5, and loaded onto an SPE cartridge packed with the reactive polymer of Example 1 (previously conditioned with 100 mM BB, pH 9.5).

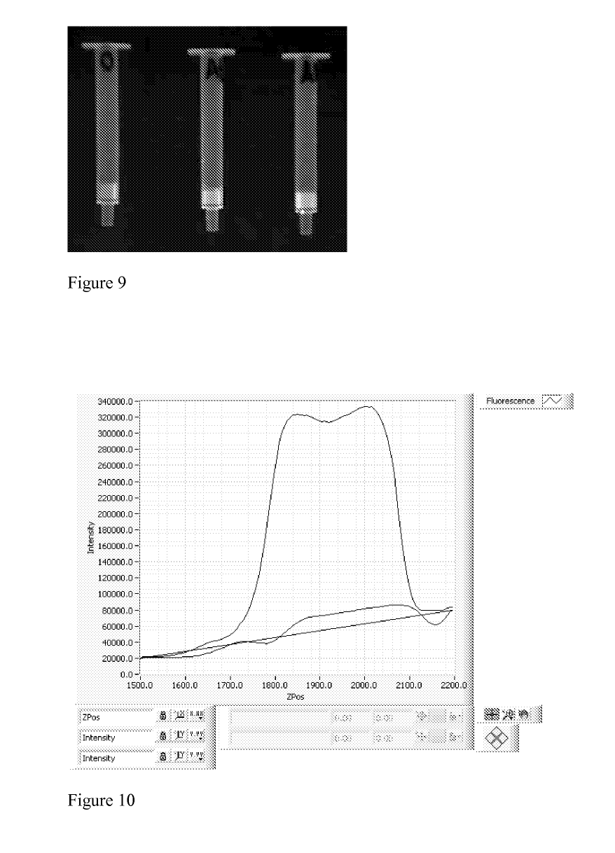

Abacavir bound to the polymer and generated an increase in fluorescence which was detected using a Toximet-T instrument and transilluminator (FIGS. 8 and 9).

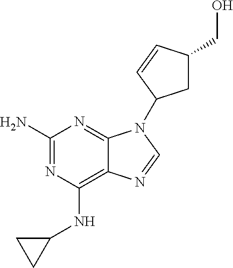

### EXAMPLE 6

### Vitamin B1

1 mg of thiamine (Vitamin B1) was dissolved in 1 ml of BB, pH 7.5, and loaded onto an SPE cartridge packed with the reactive polymer of Example 1 (previously conditioned with 100 mM BB, pH 9.5).

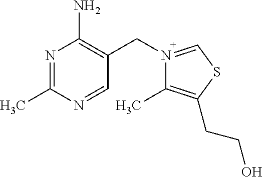

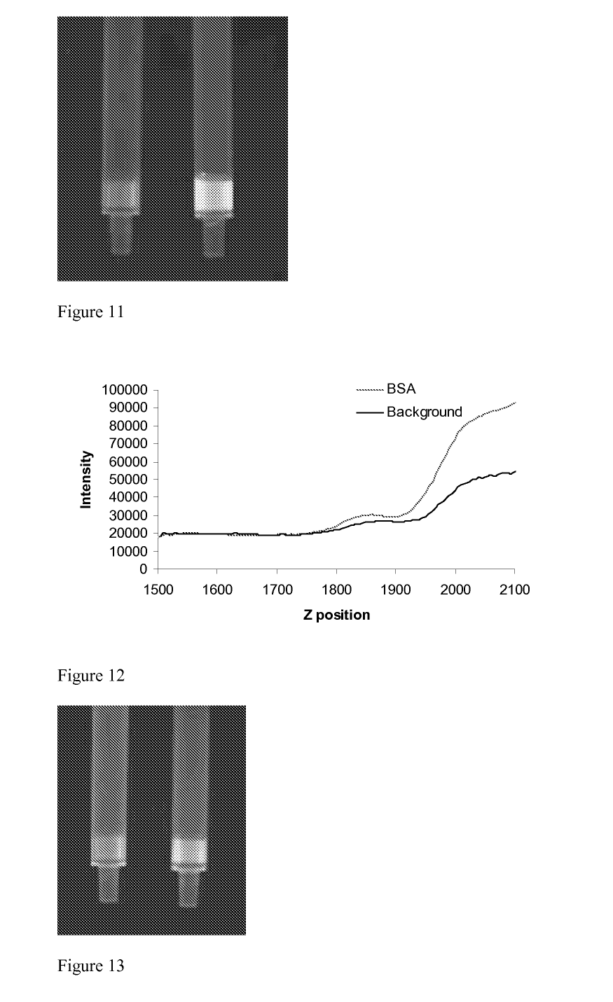

Vitamin B1 bound to the polymer and generated a significant increase in fluorescence which was detected using a Toximet-T instrument and transilluminator (FIGS. 10 and 11).

### EXAMPLE 7

### Bovine Serum Albumin (BSA)

1 mg of BSA was dissolved in 1 ml of 100 mM BB, pH 9.5, and loaded onto an SPE cartridge packed with the reactive polymer of Example 1 (previously conditioned with 100 mM BB, pH 9.5).

BSA bound to the polymer and generated an increase in fluorescence (FIGS. 12 and 13).

1. An apparatus comprising an SPE carrier loaded with a polymer, the polymer having functional monomers for binding an analyte, wherein the polymer is a reactive polymer, which, in use, binds an analyte having a primary amino group, causing fluorescent isoindole complex formation.

2. An apparatus as claimed in claim 1 wherein the reactive polymer comprises o-phthaldialdehyde and allyl thiol.

3. An apparatus as claimed in claim 2 wherein the reactive polymer further comprises EGDMA as a cross-linker and 1,1′-azobis(cyclohexanecarbonitrile) as initiator.

4. An apparatus as claimed in claim 1, wherein the reactive polymer is prepared from a monomer mixture comprising acetonitrile and triethylamine.

5. An apparatus as claimed in claim 1, wherein the SPE carrier is a cartridge, tube, cuvette, rod or flat surface.

6. An apparatus as claimed in claim 1, wherein the SPE carrier further comprises a non-reactive polymer capable of selectively binding an analyte.

7. An apparatus as claimed in claim 1, suitable for adsorbing DNA, fumonisin B1, Atenolol, Abacavir glutarate, Vitamin B1 or bovine serum albumin (BSA).

8. An apparatus as claimed in claim 1, further comprising a Toximet-T instrument and/or a transilluminator.

9. A method of analysing a sample comprising the steps of:
providing an SPE carrier loaded with a reactive polymer, the reactive polymer being suitable for binding an analyte having a primary amino group such that binding results in fluorescent isoindole complex formation;
applying the sample to the reactive polymer; and
detecting any change in fluorescence.

10. The method of claim 9 wherein the analyte is DNA, fumonisin B1, Atenolol, Abacavir glutarate, Vitamin B1 or bovine serum albumin (BSA).

11. The method of claim 9, wherein fluorescence is detected using a Toximet-T instrument and/or transilluminator.

12. The method of claim 9, wherein the reactive polymer comprises o-phthaldialdehyde and allyl thiol.

13. The method of claim 12 wherein the reactive polymer further comprises EGDMA as cross-linker and 1,-azobis(cyclohexanecarbonitrile) as initiator.

14. The method of claim 12, wherein the reactive polymer is prepared from a monomer mixture comprising acetonitrile and triethylamine.

15. The method of claim 1, wherein the SPE carrier further comprises a non-reactive polymer capable of selectively binding an analyte.

16. Use of a reactive polymer as an SPE adsorbent for adsorbing an analyte having a primary amino group, wherein adsorption causes fluorescent isoindole complex formation.

17. Use according to claim 16 wherein the reactive polymer comprises o-phthaldialdehyde, allyl thiol, EGDMA as cross-linker, 1,1′azobis(cyclohexanecarbonitrile) as initiator, acetonitrile and triethylamine.

18. (canceled)

19. (canceled)

20. An apparatus as claimed in claim 2, wherein the reactive polymer is prepared from a monomer mixture comprising acetonitrile and triethylamine.

21. An apparatus as claimed in claim 3, wherein the reactive polymer is prepared from a monomer mixture comprising acetonitrile and triethylamine.

22. An apparatus as claimed in claim 2, wherein the SPE carrier is a cartridge, tube, cuvette, rod or flat surface.
